(19) United States
(12) Patent Application Publication
(10) Pub. No.: US 2026/0098191 A1
(43) Pub. Date: Apr. 9, 2026

(54) LAMINATE

(71) Applicant: LINTEC Corporation, Tokyo (JP)

(72) Inventors: Kenta NISHIJIMA, Tokyo (JP); Tomofumi KATO, Tokyo (JP); Go ONISHI, Tokyo (JP); Takashi SUGINO, Tokyo (JP)

(21) Appl. No.: 19/113,896

(22) PCT Filed: Sep. 21, 2023
(86) PCT No.: PCT/JP2023/034249

§ 371 Date: Mar. 20, 2025

(30) Foreign Application Priority Data
Sep. 22, 2022 (JP) 2022-151756
Sep. 22, 2022 (JP) 2022-151757
Mar. 31, 2023 (JP) 2023-058459
Mar. 31, 2023 (JP) 2023-058460
Mar. 31, 2023 (JP) 2023-058462
Mar. 31, 2023 (JP) 2023-058463

(51) Int. Cl. C09J 133/08; C09J 7/10; C09J 7/38

(52) U.S. Cl. CPC C09J 133/08; C09J 7/10; C09J 7/385; C09J 2301/20; C09J 2301/302; C09J 2301/312; C09J 2301/408; C09J 2301/416; C09J 2433/00

(57) ABSTRACT

A laminate including: a pressure sensitive adhesive sheet configured to catch an element distant from a holding substrate, and a release sheet laminated on one of faces of the pressure sensitive adhesive sheet; the pressure sensitive adhesive sheet including a pressure sensitive adhesive layer, the pressure sensitive adhesive layer having an unevenness on a surface; the release sheet including a release layer that is in contact with the pressure sensitive adhesive layer, the release layer having unevenness on a surface; and a peel strength at a release angle of 180° of the release sheet with respect to the pressure sensitive adhesive sheet measured at a release speed of 300 mm/min being 1000 mN/50 mm or less.

### TECHNICAL FIELD

The present invention relates to a laminate.

### BACKGROUND ART

Elements used in electronic components or semiconductor devices are often obtained by forming a large number of elements at once. For example, semiconductor chips are obtained by dicing a semiconductor wafer adhered to a pressure sensitive adhesive. When such a semiconductor chip is mounted on a semiconductor device, transfer of the semiconductor chip is often performed. For example, Patent Document 1 describes a method (laser lift-off method) of transferring a semiconductor chip by irradiating a semiconductor chip with a laser.

### CITATION LIST

### Patent Literature

Patent Document 1: JP 2021-141181 A

### SUMMARY OF INVENTION

### Technical Problem

When the element is transferred from a substrate before the transfer to a substrate after the transfer, the element is caught by the substrate after the transfer. When such transfer of an element is performed, a position of an element on a substrate after the transfer may deviate from a position of the element on the substrate before the transfer. However, by providing unevenness on a surface of a pressure sensitive adhesive sheet catching an element to be transferred, the position displacement of the element at the time of catching can be suppressed.

Meanwhile, the pressure sensitive adhesive sheet is adhered to a release sheet until immediately before the use, and the pressure sensitive adhesive sheet is released from the release sheet and then used for the transfer of the element. However, when the pressure sensitive adhesive sheet has unevenness on its surface, the pressure sensitive adhesive sheet and the release sheet tightly bond, and releasing of the pressure sensitive adhesive sheet from the release sheet may be difficult.

An object of the present invention is to provide a laminate that can transfer an element to a proper position and that has improved releasability of a release sheet from a pressure sensitive adhesive sheet.

### Solution to Problem

As a result of diligent study, the inventors of the present invention found that adjusting peel strength of a release sheet for a pressure sensitive adhesive sheet having unevenness can solve the problems described above, further conducted various study, and thus completed the present invention.

That is, the present invention relates to [1] to [12] below.

[1] A laminate including: a pressure sensitive adhesive sheet configured to catch an element distant from a holding substrate, and a release sheet laminated on one of faces of the pressure sensitive adhesive sheet;
the pressure sensitive adhesive sheet including a pressure sensitive adhesive layer,
the pressure sensitive adhesive layer having unevenness on a surface;
the release sheet including a release layer that is in contact with the pressure sensitive adhesive layer, the release layer having unevenness on a surface; and
a peel strength at a release angle of 180° of the release sheet with respect to the pressure sensitive adhesive sheet measured at a release speed of 300 mm/min being 1000 mN/50 mm or less.
   [2] The laminate according to [1], where the release layer contains a non-silicone-based release agent.
   [3] The laminate according to [1] or [2], where the release layer contains a non-silicone olefin-based release agent.
   [4] The laminate according to any one of [1] to [3], where the unevenness of the surface of the pressure sensitive adhesive layer is in a complementary relationship with the unevenness of the surface of the release layer.
   [5] The laminate according to any one of [1] to [4], where the release layer has a plurality of recessed portions on a surface of the release layer, each of the plurality of recessed portions having a boundary defined by a protruded portion, the plurality of recessed portions being separated from each other, and a depth of a recessed portion of the release layer is 1 μm or greater.
   [6] The laminate according to any one of [1] to [5], where the pressure sensitive adhesive layer is made of a pressure sensitive adhesive composition containing an energy ray-curable compound (B).
   [7] The laminate according to any one of [1] to [6], where the pressure sensitive adhesive layer is made of a pressure sensitive adhesive composition containing an acrylic resin (A).
   [8] The laminate according to any one of [1] to [7], where the pressure sensitive adhesive layer is made of a pressure sensitive adhesive composition containing an acrylic resin (A) and an energy ray-curable compound (B).
   [9] The laminate according to any one of [1] to [8], where the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and a pitch between the plurality of protruded portions of the pressure sensitive adhesive layer is 1 μm or greater and 100 μm or less.
   [10] The laminate according to any one of [1] to [9], where the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and an area of each of the plurality of protruded portions of the pressure sensitive adhesive layer is 10 μm² or greater and 2000 μm² or less.
   [11] The laminate according to any one of [1] to [10], where the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and a ratio of an area of the protruded portion of the pressure sensitive adhesive layer to an area of the pressure sensitive adhesive layer is 1% or greater and 95% or less.
   [12] The laminate according to any one of [1] to [11], where the pressure sensitive adhesive layer has a ratio of an adhesion area of the pressure sensitive adhesive layer and one element to an area of the one element of 1% or greater and 95% or less.

### Advantageous Effects of Invention

The present invention can provide a laminate that can transfer an element to a proper position and that has improved releasability of a release sheet from a pressure sensitive adhesive sheet.

### BRIEF DESCRIPTION OF DRAWINGS

The accompanying drawings incorporated in and forming a part of the description illustrate embodiments of the present invention, and together with the description serve to explain the principles of the present invention.

FIG. 1 is a schematic view of a laminate according to an embodiment.

FIG. 2A is a top view of an example of unevenness included in a pressure sensitive adhesive sheet.

FIG. 2B is a top view of an example of unevenness included in a pressure sensitive adhesive sheet.

FIG. 2C is a top view of an example of unevenness included in a pressure sensitive adhesive sheet.

FIG. 3A is a cross-sectional view of an example of unevenness included in a pressure sensitive adhesive sheet.

FIG. 3B is a cross-sectional view of an example of unevenness included in a pressure sensitive adhesive sheet.

FIG. 4A is a schematic view explaining separation and catching of an element.

FIG. 4B is a schematic view explaining separation and catching of an element.

FIG. 4C is a schematic view explaining separation and catching of an element.

FIG. 5A is a top view of an example of unevenness included in a release sheet.

FIG. 5B is a top view of an example of unevenness included in a release sheet.

FIG. 5C is a top view of an example of unevenness included in a release sheet.

FIG. 6A is a cross-sectional view of an example of unevenness included in a release sheet.

FIG. 6B is a cross-sectional view of an example of unevenness included in a release sheet.

### DESCRIPTION OF EMBODIMENTS

Embodiments will be described in detail below with reference to the attached drawings. Note that the following embodiments are not intended to limit the scope of the claimed invention, and the invention does not necessarily require all combinations of features described in the embodiments. Two or more of the multiple features described in the embodiments may be combined as appropriate. Furthermore, the same reference numerals are given to the same or similar configurations, and redundant description thereof is omitted.

### Definition

In the present description, the mass average molecular weight (Mw) and the number average molecular weight (Mn) are values measured by a size exclusion chromatography method calibrated with a polystyrene standard, and more specifically, are values measured based on JIS K 7252-1:2016. In addition, in the present description, “(meth)acrylic acid” is a term referring to both “acrylic acid” and “methacrylic acid”, and the same shall apply to other similar terms.

In the present description, “electronic component” includes all components used in electronics, electrical engineering, and the like, and includes all components constituting electronic devices. “Electronic component” may be made of a semiconductor, an electric conductor, and/or an insulator or may be made of a combination of these. Examples of “electronic component” include active components (that are mainly made of semiconductors; examples thereof include a transistor, IC, LSI, VLSI, a diode, a light emitting diode, a thyristor, a 3-terminal regulator, and an image sensor), passive elements (examples thereof include a resistor, a capacitor, a speaker, a coil, a transformer, a power transformer, a relay, a piezoelectric element, a quartz crystal unit, a ceramic resonator, and a varistor), and structural components (examples thereof include a wiring component, a printed-circuit board, a connector, and a switch). Furthermore, in the present specification, “semiconductor device” refers to devices that can function by utilizing semiconducting properties in general, such devices being used for processors, memories, sensors, and the like. Examples of “semiconductor device” include a micro LED, a mini LED, a power device, micro-electromechanical systems (MEMS), and a controller chip.

In the present specification, a case where one or more lower limit values and one or more upper limit values are described for a numerical range (e.g., range of content) can be understood as a description of a combination of a lower limit value and an upper limit value that are freely chosen therefrom. For example, the description of 1 or greater, 2 or greater, and 3 or greater, and 9 or less, 8 or less, and 7 or less clearly means that the numerical range may be any one of 1 or greater and 9 or less, 1 or greater and 8 or less, 1 or greater and 7 or less, 2 or greater and 9 or less, 2 or greater and 8 or less, 2 or greater and 7 or less, 3 or greater and 9 or less, 3 or greater and 8 or less, or 3 or greater and 7 or less.

### Laminate According to Present Embodiment

A laminate according to the present embodiment includes a pressure sensitive adhesive sheet configured to catch an element distant from a holding substrate, and a release sheet laminated on one of faces of the pressure sensitive adhesive sheet. The pressure sensitive adhesive sheet includes a pressure sensitive adhesive layer, and the pressure sensitive adhesive layer has an unevenness on a surface. The release sheet includes a release layer that is in contact with the pressure sensitive adhesive layer, and the release layer has an unevenness on a surface. By this, an element can be transferred to a proper position. Furthermore, a peel strength at a release angle of 180° of the release sheet with respect to the pressure sensitive adhesive sheet measured at a release speed of 300 mm/min is 1000 mN/50 mm or less. By this, releasability of the release sheet from the pressure sensitive adhesive sheet can be improved, and the pressure sensitive adhesive sheet can be released easily from the release sheet.

### Configuration of Laminate

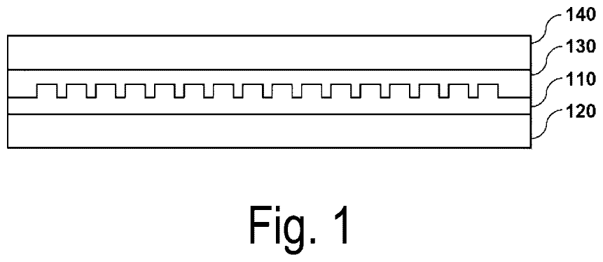

FIG. 1 is a schematic view of a laminate according to an embodiment. In an embodiment, the laminate may include a pressure sensitive adhesive layer 110, a pressure sensitive adhesive sheet base material 120, a release layer 130, and a release sheet base material 140. The pressure sensitive adhesive sheet and the release sheet are not required to have the pressure sensitive adhesive sheet base material 120 and the release sheet base material 140. For example, the pressure sensitive adhesive sheet may be made only of a pressure sensitive adhesive layer 110, and the release sheet may be only made of a release layer 130. In this case, a pressure sensitive adhesive layer 110 and a release layer 130 that have high supportability can be used.

In the laminate, typically, the pressure sensitive adhesive sheet and the release sheet are adhered until immediately before use. The above-mentioned characteristics of the laminate can be varied based on the compositions and properties of the pressure sensitive adhesive sheet and the release sheet described below. Furthermore, in an embodiment, a laminate can be obtained by adhering a pressure sensitive adhesive sheet and a release sheet in a manner that a pressure sensitive adhesive layer 110 of the pressure sensitive adhesive sheet and a release layer 130 of the release sheet are in contact. Note that the laminate may be formed by forming a pressure sensitive adhesive layer 110 on a release layer 130 of a release sheet having unevenness and then adhering a pressure sensitive adhesive sheet base material 120 on the pressure sensitive adhesive layer 110. Details of each configuration will be described below.

### Peel Strength

The laminate according to the present embodiment has a peel strength at a release angle of 180° of the release sheet with respect to the pressure sensitive adhesive sheet measured at a release speed of 300 mm/min of 1000 mN/50 mm or less. The upper limit of the peel strength of the release sheet with respect to the pressure sensitive adhesive sheet can be preferably 1000 mN/50 mm or less, more preferably 800 mN/50 mm or less, even more preferably 500 mN/50 mm or less, yet even more preferably 200 mN/50 mm or less, and particularly preferably 100 mN/50 mm or less. By this, releasability of the release sheet from the pressure sensitive adhesive sheet can be improved, and the pressure sensitive adhesive sheet having unevenness on its surface can be released easily from the release sheet.

On the other hand, the lower limit of the peel strength of the release sheet with respect to the pressure sensitive adhesive sheet can be, but not particularly limited to, preferably 1 mN/50 mm or greater, more preferably 2 mN/5 mm or greater, even more preferably 10 mN/50 mm or greater, yet even more preferably 15 mN/50 mm or greater, and particularly preferably 20 mN/50 mm or greater. By this, the laminate can be maintained as a laminate. The range of the peel strength of the laminate can be preferably 1 mN/50 mm or greater and 1000 mN/50 mm or less, more preferably 2 mN/5 mm or greater and 800 mN/50 mm or less, even more preferably 10 mN/50 mm or greater and 500 mN/50 mm or less, yet even more preferably 15 mN/50 mm or greater and 200 mN/50 mm or less, and particularly preferably 20 mN/50 mm or greater and 100 mN/50 mm or less.

A method for measuring peel strength of a release sheet with respect to a pressure sensitive adhesive sheet will be described in Examples.

### Pressure Sensitive Adhesive Sheet

### Pressure Sensitive Adhesive Layer

The pressure sensitive adhesive sheet according to the present embodiment includes a pressure sensitive adhesive layer 110 and the pressure sensitive adhesive layer 110 is a layer exhibiting pressure sensitive adhesion and may contain a resin. Furthermore, the pressure sensitive adhesive sheet may include two or more pressure sensitive adhesive layers 110. For example, the pressure sensitive adhesive sheet may include a laminate of one type or two or more types of pressure sensitive adhesive layer 110. Furthermore, a surface of the pressure sensitive adhesive layer 110 has unevenness. The pressure sensitive adhesive sheet catches an element separated from a holding substrate on the pressure sensitive adhesive layer 110, and a gas compressed in between the element and the pressure sensitive adhesive layer 110 caused by approach of the element and the pressure sensitive adhesive layer 110 is allowed to escape to a recessed portion of the pressure sensitive adhesive sheet. By this, pressure caused between the element and the pressure sensitive adhesive layer can be relaxed. Details of catching of the element by the pressure sensitive adhesive sheet will be described below.

### Form of Pressure Sensitive Adhesive Layer

When the surface of the pressure sensitive adhesive layer 110 has a recessed portion, the pressure caused between the element and the pressure sensitive adhesive layer can be relaxed, and displacement of holding position of an element on the pressure sensitive adhesive sheet can be suppressed. Thus, specific forms of unevenness included on the surface of the pressure sensitive adhesive layer 110 are not limited. Meanwhile, the unevenness of the surface of the pressure sensitive adhesive layer 110 are in a complementary relationship with unevenness of a surface of a release layer described below.

In an embodiment, the pressure sensitive adhesive layer 110 includes a plurality of protruded portions that are separated from each other, and each of the plurality of protruded portions has a boundary defined by a recessed portion, on the surface of the pressure sensitive adhesive layer 110. Each of the plurality of protruded portions may be separated by a recessed portion continuous on the whole pressure sensitive adhesive layer 110. By providing such a continuous recessed portion around the protruded portions, the pressure relaxation effect can be enhanced.

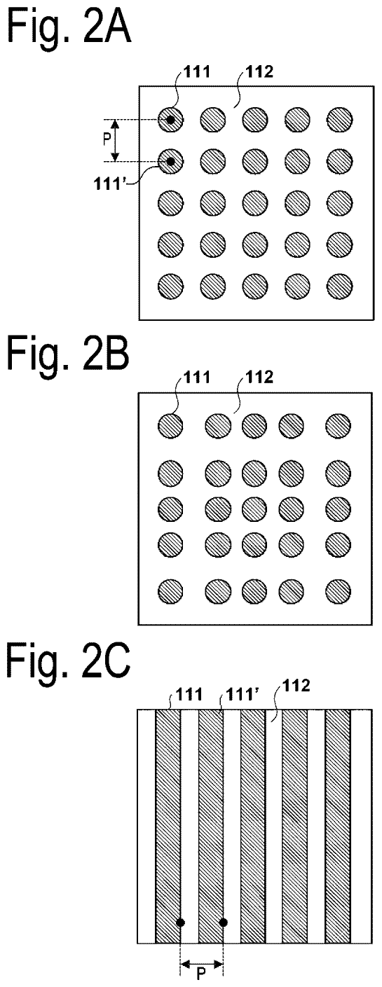

In an embodiment, a recessed portion positioned around each of the plurality of protruded portions continues to edges of the pressure sensitive adhesive layer 110. By providing a recessed portion continuing to edges of the pressure sensitive adhesive layer 110 as described above, a gas compressed between an element and the protruded portion of the pressure sensitive adhesive layer 110 can be allowed to escape outside of the element efficiently. FIG. 2A to FIG. 2C are top views illustrating forms of such pressure sensitive adhesive layers 110.

As illustrated in FIG. 2A, the protruded portions 111 may be regularly arranged on the surface of the pressure sensitive adhesive layer 110. Regular arrangement of the protruded portions 111 means that the protruded portions 111 are arranged in a straight line at a regular interval. Furthermore, as illustrated in FIG. 2B, the protruded portions 111 may be arranged in a manner that the spacing therebetween varies regularly. In the example of FIG. 2B, the spacing between the protruded portions 111 is smaller in a central part of the pressure sensitive adhesive sheet, and the spacing between the protruded portions 111 is longer in a peripheral part of the pressure sensitive adhesive sheet. According to such configuration, a compressed gas can be effectively allowed to escape from the peripheral part of the element through a wider recessed portion while the holding capability of the pressure sensitive adhesive sheet is enhanced. Furthermore, the protruded portions 111 may be arranged irregularly.

FIG. 2C is a top view illustrating another form of the pressure sensitive adhesive layer 110. As illustrated in FIG. 2C, the surface of the pressure sensitive adhesive layer 110 may have protruded portions 111 in a stripe form. In FIG. 2C, linear protruded portions 111 having a fixed width are arranged at a regular interval. Meanwhile, similarly to FIG. 2B, widths or spacing of the linear protruded portions 111 may vary regularly, or the linear protruded portions 111 may be arranged irregularly.

Note that, similarly to FIG. 2B, the smallest spacing among all spacing of the protruded portions 111 in a central part of the pressure sensitive adhesive sheet may be shorter than the smallest spacing among all spacing of the protruded portions 111 in the peripheral part of the pressure sensitive adhesive sheet. Note that, for example, the central part is a circular region having ¼ area of the pressure sensitive adhesive sheet and having a center at the center of gravity of the pressure sensitive adhesive sheet. For example, the peripheral part is all region except the central part of the pressure sensitive adhesive sheet.

From the viewpoint of enhancing the pressure relaxation effect, a pitch P of the protruded portions 111 is preferably 1 μm or greater, more preferably 5 μm or greater, even more preferably 10 μm or greater, and particularly preferably 15 μm or greater. Meanwhile, from the viewpoint of suppressing position displacement at the time of catching by increasing the contact area of the pressure sensitive adhesive layer 110 and the element, this pitch is preferably 100 μm or less, more preferably 75 μm or less, even more preferably 50 μm or less, yet even more preferably 35 μm or less, and particularly preferably 25 μm or less. Note that the pitch of the protruded portions 111 means a distance between a center point of one freely chosen protruded portion 111 and a center point of a protruded portion 111 that is the closest to the chosen protruded portion 111. For example, in the case of FIG. 2A, the pitch of the protruded portions 111 is a distance between a center point of the protruded portion 111 in the straight line, where protruded portions 111 are arranged at a regular interval, and a center point of another protruded portion 111′ that is the closest to the protruded portion 111. In a case where the plurality of the protruded portions 111 is arranged in a straight line, the pitch refers to a distance between center points of protruded portions that are arranged with the shortest pitch in the straight line. Furthermore, for example, in a case where a center point of a protruded portion is difficult to be identified due to a long and narrow form as illustrated in FIG. 2C, the spacing refers to a distance from a boundary of the protruded portion 111 to a boundary of the same side of the closest another protruded portion 111′.

The specific form of the protruded portion 111 is not particularly limited. For example, the protruded portion 111 may have a pillar (column) form. As a specific example, the protruded portion 111 may have a circular cylindrical shape or may have a prism shape. Furthermore, the protruded portion 111 may be extended in a line form as described above or may be extended in a curve form, such as a wave form. Furthermore, these protruded portions 111 may be tapered.

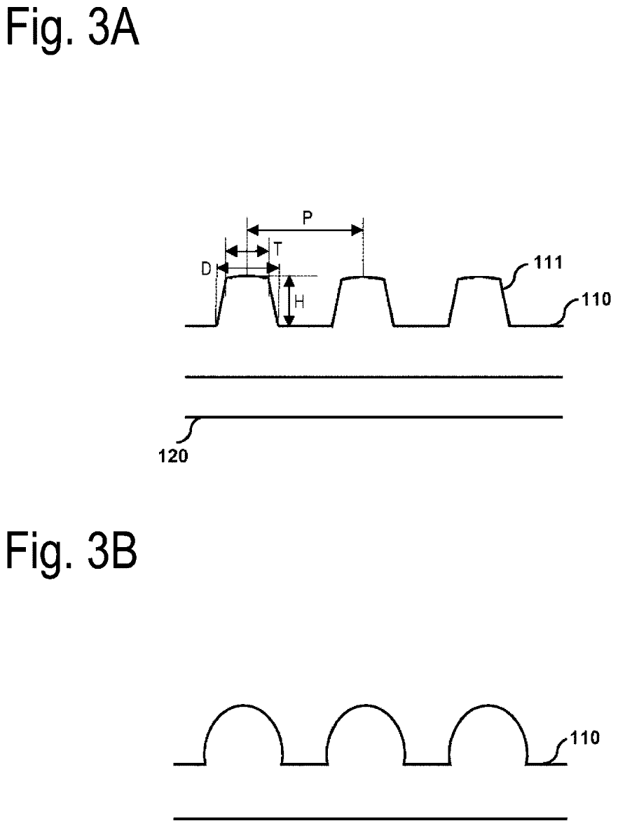

FIG. 3A illustrates a cross-sectional view seen vertically with respect to a surface of a pressure sensitive adhesive layer 110 passing through a protruded portion 111 of the pressure sensitive adhesive layer 110 according to an embodiment. The protruded portion 111 illustrated in FIG. 3A is provided with a taper, that is, the protruded portion 111 is tapered. As illustrated in FIG. 3A, a surface of the pressure sensitive adhesive layer 110 may include a flat recessed portion, and protruded portions 111 that protrude from the recessed portion. As described above, a plurality of protruded portions 111, which are separated from each other included in the pressure sensitive adhesive layer 110, may have boundaries defined by the recessed portion.

Furthermore, as illustrated in FIG. 3B, the tip of the protruded portion 111 may be semispherical or a curved face similar to a part of a sphere. According to such a configuration, impact at the time of contact of the element separated from a holding substrate and the pressure sensitive adhesive layer 110 is more relaxed, catching of the element by the pressure sensitive adhesive layer 110 at a proper position is facilitated. Meanwhile, the tip of the protruded portion may be a flat face.

Furthermore, the protruded portion 111 may be a form having a plurality of particles aggregated, a form of lotus leaf surface, or a needle form. As other examples, the surface of the pressure sensitive adhesive layer 110 may be a rough surface or fibrous surface, and these surfaces can be said to have unevenness.

The width or size of each of the protruded portions 111 is a width or size of a base part, not a tip part, and from the viewpoints of enhancing adhesion and suppressing position displacement at the time of catching, the width or size thereof is preferably 1 μm or greater, more preferably 2 μm or greater, even more preferably 5 μm or greater, and particularly preferably 10 μm or greater. Meanwhile, the width or size thereof is preferably 100 μm or less, more preferably 50 μm or less, even more preferably 30 μm or less, and particularly preferably 20 μm or less. Note that the width and the size of a protruded portion 111 respectively mean a minimum distance and a maximum distance between two parallel lines that are in contact with both sides of the protruded portion 111 at a surface of the recessed portion (represented as D in FIG. 3A).

Furthermore, from the viewpoints of enhancing adhesion and suppressing position displacement at the time of catching, the area of each of the protruded portions 111 is preferably 10 μm² or greater, more preferably 20 μm² or greater, and even more preferably 30 μm² or greater. Meanwhile, from the viewpoint of enhancing pressure relaxation effect, the area of each of the protruded portions 111 is preferably 2000 μm² or less, more preferably 1000 μm² or less, and even more preferably 500 μm² or less. Note that the area of the protruded portion 111 means an area of a part protruded from the surface of the recessed portion (area of a circle having a diameter D in the case of FIG. 3A).

Furthermore, from the viewpoints of enhancing shock absorbency and suppressing position displacement at the time of catching, the height of each of the protruded portions 111 is preferably 1 μm or greater, more preferably 3 μm or greater, and even more preferably 5 μm or greater. Meanwhile, from the viewpoint of enhancing shape stability, the height of each of the protruded portions 111 is preferably 20 μm or less, more preferably 15 μm or less, and even more preferably 10 μm or less. Note that the height of the protruded portion 111 is represented as H in FIG. 3A.

Furthermore, from the viewpoints of enhancing adhesion and suppressing position displacement at the time of catching, the area of each of the protruded portions 111 with respect to the area of the pressure sensitive adhesive layer 110 is preferably 1% or greater, more preferably 5% or greater, even more preferably 10% or greater, yet even more preferably 18% or greater, and particularly preferably 40% or greater. Meanwhile, from the viewpoint of enhancing pressure relaxation effect, the area of each of the protruded portions with respect to the area of the pressure sensitive adhesive layer 110 is preferably 95% or less, more preferably 75% or less, and even more preferably 60% or less.

The unevenness included in the pressure sensitive adhesive layer 110 may be designed based on a form of an element held by the pressure sensitive adhesive sheet. For example, from the viewpoints of enhancing adhesion and suppressing position displacement at the time of catching, a ratio of an adhesion area between the pressure sensitive adhesive layer 110 and one element with respect to an area of the one element is preferably 1% or greater, more preferably 2% or greater, even more preferably 3% or greater, yet even more preferably 4% or greater, yet even more preferably 5% or greater, yet even more preferably 7% or greater, and particularly preferably 10% or greater, with respect to 100% area of one element. Meanwhile, from the viewpoint of enhancing pressure relaxation effect, the ratio of the adhesion area between the pressure sensitive adhesive layer 110 and one element with respect to an area of the one element is preferably 95% or less, more preferably 70% or less, even more preferably 50% or less, and particularly preferably 30% or less. In the case of FIG. 3A, the adhesion area corresponds to an area of a circle having a diameter T. Note that, in a case where a catching position of an element is displaced on the pressure sensitive adhesive sheet, the adhesion area may vary. In this case, the ratio of adhesion area may fall within the range described above regardless of the catching position of the element.

### Thickness of Pressure Sensitive Adhesive Layer

From the viewpoint of adhesion, the thickness of the pressure sensitive adhesive layer 110 can be, but not particularly limited to, preferably 1 μm or greater, more preferably 5 μm or greater, and even more preferably 10 μm or greater, and preferably 70 μm or less, more preferably 50 μm or less, and even more preferably 40 μm or less. The range of the thickness of the pressure sensitive adhesive layer 110 can be preferably 1 μm or greater and 70 μm or less, more preferably 5 μm or greater and 50 μm or less, and even more preferably 10 μm or greater and 40 μm or less.

### Composition of Pressure Sensitive Adhesive Layer (Pressure Sensitive Adhesive Composition)

The pressure sensitive adhesive composition constituting the pressure sensitive adhesive layer 110 contains a resin. Examples of the resin contained in the pressure sensitive adhesive composition include rubber-based resins, such as polyisobutylene-based resins, polybutadiene-based resins, and styrene-butadiene-based resins, acrylic resins, urethane-based resins, polyester-based resins, olefin-based resins, silicone-based resins, and polyvinyl ether-based resins. Furthermore, the pressure sensitive adhesive layer may have heat resistance, and examples of a raw material of the pressure sensitive adhesive layer having such heat resistance include polyimide-based resins and silicone-based resins. The pressure sensitive adhesive composition constituting the pressure sensitive adhesive layer 110 may contain a copolymer containing two or more types of constitutional units. The form of such a copolymer is not particularly limited. The copolymer may be any of a block copolymer, a random copolymer, an alternating copolymer, or a graft copolymer. Furthermore, the resin contained in the pressure sensitive adhesive composition constituting the pressure sensitive adhesive layer 110 may be made of one type of resin or may be made of two or more types of resins.

The resin contained in the pressure sensitive adhesive composition constituting the pressure sensitive adhesive layer 110 can be a pressure sensitive adhesive resin having pressure sensitive adhesion by itself. Furthermore, the resin can be a polymer having a mass average molecular weight (Mw) of 10000 or greater. From the viewpoint of enhancing adhesive strength, the mass average molecular weight (Mw) of the resin is preferably 10000 or greater, more preferably 70000 or greater, and even more preferably 140000 or greater. Furthermore, from the viewpoint of suppressing the elastic modulus to a predetermined value or less, the mass average molecular weight (Mw) of the resin is preferably 2000000 or less, more preferably 1200000 or less, and even more preferably 900000 or less. Furthermore, from the viewpoint of enhancing adhesive strength, the number average molecular weight (Mn) of the resin is preferably 10000 or greater, more preferably 50000 or greater, and even more preferably 100000 or greater. Furthermore, from the viewpoint of suppressing the elastic modulus to a predetermined value or less, the number average molecular weight (Mn) of the resin is preferably 2000000 or less, more preferably 1000000 or less, and even more preferably 700000 or less. In a case where the pressure sensitive adhesive layer 110 contains a resin derived from an energy ray-curable resin as described below, the mass average molecular weight (Mw) and the number average molecular weight (Mn) refer to a mass average molecular weight (Mw) and a number average molecular weight (Mn) before cross-linking reaction caused by provided energy.

Furthermore, from the viewpoint of enhancing adhesive strength, the glass transition temperature (Tg) of the resin is preferably −75° C. or higher, and more preferably −70° C. or higher, and preferably −10° C. or lower, and more preferably-20° C. or lower.

The amount of the resin with respect to the entire amount of components constituting the pressure sensitive adhesive composition forming the pressure sensitive adhesive layer 110 can be appropriately set based on the adhesive strength of a desired pressure sensitive adhesive layer 110 and is preferably 30 mass % or greater, more preferably 40 mass % or greater, even more preferably 50 mass % or greater, yet even more preferably 55 mass % or greater, and particularly preferably 60 mass % or greater, and preferably 99.99 mass % or less, more preferably 99.95 mass % or less, and even more preferably 99.90 mass % or less.

### Thermoplastic Resin

In an embodiment, the resin contained in the pressure sensitive adhesive composition forming the pressure sensitive adhesive layer 110 may contain a thermoplastic resin. That is, the pressure sensitive adhesive layer 110 may be made of a thermoplastic resin. In a case where a thermoplastic resin is used, formation of unevenness on the pressure sensitive adhesive layer 110 is facilitated by softening a resin by heating, and unevenness shapes formed by cooling of the resin can be easily maintained. Examples of the thermoplastic resin include rubber-based resins, acrylic resins, urethane-based resins, and olefin-based resins. Examples thereof include polybutadiene-based thermoplastic elastomers using butadiene as a monomer, styrene-based thermoplastic elastomers using styrene as a monomer, and acrylic thermoplastic elastomers using a (meth)acrylate as a monomer.

### Acrylic Resin (A)

In an embodiment, the thermoplastic resin can be an acrylic resin (A). From the viewpoint of enhancing adhesive strength, the mass average molecular weight (Mw) of the acrylic resin (A) is preferably 10000 or greater, more preferably 100000 or greater, and even more preferably 500000 or greater. Furthermore, from the viewpoint of suppressing the elastic modulus to a predetermined value or less, the mass average molecular weight (Mw) of the acrylic resin (A) is preferably 2000000 or less, more preferably 1500000 or less, and even more preferably 1000000 or less.

From the viewpoint of enhancing adhesive strength, the glass transition temperature (Tg) of the acrylic resin (A) is preferably −75° C. or higher, and more preferably −70° C. or higher, and preferably 75° C. or lower, more preferably 25° C. or lower, and even more preferably −55° C. or lower.

In the case of the acrylic resin (A) having two or more constitutional units, the glass transition temperature (Tg) of the acrylic resin (A) can be calculated using Fox equation. For the Tg of the monomer deriving the constitutional unit used here, a value described in Polymer Data Handbook or Pressure Sensitive Adhesion Handbook can be used.

Examples of the (meth)acrylate constituting the acrylic resin (A) include alkyl (meth)acrylates in which the alkyl group constituting the alkyl ester has a chain structure having from 1 to 18 carbons, such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, pentyl (meth)acrylate, hexyl (meth)acrylate, heptyl (meth)acrylate, 2-ethylhexyl (meth)acrylate, isooctyl (meth)acrylate, n-octyl (meth)acrylate, n-nonyl (meth)acrylate, isononyl (meth)acrylate, decyl (meth)acrylate, undecyl (meth)acrylate, lauryl (meth)acrylate, tridecyl (meth)acrylate, myristyl (meth)acrylate, pentadecyl (meth)acrylate, palmityl (meth)acrylate, heptadecyl (meth)acrylate, and stearyl (meth)acrylate; cycloalkyl (meth)acrylates, such as isobornyl (meth)acrylate and dicyclopentanyl (meth)acrylate; aralkyl (meth)acrylates, such as benzyl (meth)acrylate; cycloalkenyl (meth)acrylates, such as dicyclopentenyl (meth)acrylate; cycloalkenyloxyalkyl (meth)acrylates, such as dicyclopentenyloxyethyl (meth)acrylate; (meth)acrylic imide; glycidyl group-containing (meth)acrylates, such as glycidyl (meth)acrylate; hydroxy group-containing (meth)acrylates, such as hydroxymethyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; and substituted amino group-containing (meth)acrylates, such as N-methylaminoethyl (meth)acrylate. Note that the “substituted amino group” means a group having a structure in which one or two hydrogen atoms of an amino group are substituted with a group other than hydrogen atoms.

The acrylic resin (A) may be a resin obtained by copolymerization of one type or two or more types of monomers selected from, for example, (meth)acrylic acid, itaconic acid, vinyl acetate, acrylonitrile, styrene, and N-methylolacrylamide in addition to (meth)acrylates.

The acrylic resin (A) may be constituted of only one type or two or more types of monomers. When two or more types of monomers constitute the acrylic resin (A), their combination and ratio can be freely chosen.

Besides the hydroxy group, the acrylic resin (A) may have a functional group, such as a vinyl group, a (meth)acryloyl group, an amino group, a carboxy group, and an isocyanate group, that can be bonded to another compound. These functional groups such as the hydroxy group of the acrylic resin (A) may be bonded to another compound via a cross-linking agent (C) described below or may be directly bonded to another compound without the cross-linking agent (C).

The amount of the acrylic resin (A) with respect to the entire amount of the resin of the pressure sensitive adhesive composition can be appropriately set based on the adhesive strength of a desired pressure sensitive adhesive layer 110 and is preferably 0 mass % or greater, more preferably 10 mass % or greater, even more preferably 20 mass % or greater, and particularly preferably 50 mass % or greater, and preferably 100 mass % or less, more preferably 95 mass % or less, even more preferably 80 mass % or less, and particularly preferably 60 mass % or less.

### Energy Ray-Curable Resin (B)

In an embodiment, the resin contained in the pressure sensitive adhesive composition forming the pressure sensitive adhesive layer 110 may contain an energy ray-curable resin (B). “Energy ray-curable” means a property of being cured by irradiation with an energy ray, and the energy ray-curable resin (B) refers to a resin that is cured by irradiation with an energy ray. Furthermore, “energy ray” means an electromagnetic wave or a charged particle beam having an energy quantum, and examples include ultraviolet rays, radiation, and electron beams. The ultraviolet rays can be irradiated by using, for example, an electrodeless lamp, a high-pressure mercury lamp, a metal halide lamp, or a UV-LED as an ultraviolet ray source. The electron beam can be generated by an electron beam accelerator or the like and irradiated. Furthermore, “energy ray-polymerizable” refers to a property of being polymerized by irradiation with energy rays.

In a case where such an energy ray-curable resin (B) is used, by providing an energy after unevenness is formed on a resin (e.g., irradiation with an energy ray), the formed unevenness shape can be easily maintained.

As the energy ray-curable resin (B), a monomer, an oligomer, and a polymer, to which a polymerizable functional group has been introduced can be used. The polymerizable functional group is a functional group that is cross-linked when energy is provided (e.g., irradiation of an energy ray). Examples of the polymerizable functional group include a vinyl group, an alkenyl group such as an allyl group, a (meth)acryloyl group, an oxetanyl group, and an epoxy group.

From the viewpoint of enhancing adhesive strength, the mass average molecular weight (Mw) of the energy ray-curable resin (B) is preferably 100 or greater, and more preferably 150 or greater. Furthermore, from the viewpoint of suppressing the elastic modulus to a predetermined value or less, the mass average molecular weight (Mw) of the energy ray-curable resin (B) is preferably 2000000 or less, more preferably 1000000 or less, and even more preferably 200000 or less. When a monomer or an oligomer is used as the energy ray-curable resin (B), the number average molecular weight (Mn) of the energy ray-curable resin (B) is preferably 100 or greater, and more preferably 150 or greater, from the viewpoint of polymerizability. Furthermore, from the viewpoint of suppressing the elastic modulus to a predetermined value or less, the number average molecular weight (Mn) of the energy ray-curable resin (B) is preferably 5000 or less, more preferably 1000 or less, and even more preferably 500 or less. When a polymer is used as the energy ray-curable resin (B), the mass average molecular weight (Mw) of the energy ray-curable resin (B) is preferably 10000 or greater, more preferably 50000 or greater, and even more preferably 100000 or greater, from the viewpoint of enhancing adhesive strength. Furthermore, from the viewpoint of suppressing the elastic modulus to a predetermined value or less, the mass average molecular weight (Mw) of the energy ray-curable resin (B) is preferably 2000000 or less, more preferably 500000 or less, and even more preferably 300000 or less.

The average value of the number of the polymerizable functional groups per molecule in the energy ray-curable resin (B) is preferably 1.5 or greater, and more preferably 2 or greater, from the viewpoint of facilitating maintenance of unevenness shapes of the pressure sensitive adhesive layer. Meanwhile, from the viewpoint of enhancing pressure sensitive adhesion and flexibility of the pressure sensitive adhesive layer, this average value is preferably 20 or less, more preferably 15 or less, and even more preferably 10 or less.

In an embodiment, as the energy ray-curable resin (B), a monomer or oligomer having a polymerizable functional group can be used. Examples of the energy ray-curable compound include polyvalent (meth)acrylate monomers, such as glycerin di(meth)acrylate, glycerin tri(meth)acrylate, 1,4-butylene glycol di(meth)acrylate, 1,6-hexanediol (meth)acrylate, trimethylolpropane tri(meth)acrylate, pentaerythritol (meth)acrylate, pentaerythritol tetra(meth)acrylate, dipentaerythritol hexa(meth)acrylate, and tricyclodecane dimethanol di(meth)acrylate; urethane (meth)acrylate; polyester (meth)acrylate; polyether (meth)acrylate; and epoxy (meth)acrylate. Among these, from the viewpoint of maintaining the formed unevenness shape, glycerin di(meth)acrylate, glycerin tri(meth)acrylate, and tricyclodecane dimethanol di(meth)acrylate are preferred.

In an embodiment, as the energy ray-curable resin (B), a diene-based rubber made of a polymer having a polymerizable functional group in a main chain terminal and/or a side chain can be used. The diene-based rubber refers to a rubber-like polymer having a double bond in a polymer main chain. Specific examples of the diene-based rubber include a polymer using butadiene or isoprene as a monomer (that is, containing a butenediyl group or a pentenediyl group as a constitutional unit). In an embodiment, examples of the energy ray-curable resin (B) include a polybutadiene resin, a styrene-butadiene-styrene block copolymer, and a styrene-isoprene-styrene block copolymer.

The amount of the energy ray-curable resin (B) with respect to the entire amount of the resin of the pressure sensitive adhesive composition can be appropriately set based on the adhesive strength of a desired pressure sensitive adhesive layer 110 and is preferably 0 mass % or greater, more preferably 10 mass % or greater, even more preferably 20 mass % or greater, and particularly preferably 50 mass % or greater, and preferably 100 mass % or less, more preferably 95 mass % or less, even more preferably 80 mass % or less, and particularly preferably 60 mass % or less.

Furthermore, in an embodiment, the pressure sensitive adhesive composition may contain an acrylic resin (A) and an energy ray-curable resin (B). The relationship between the content of the acrylic resin (A) and the content of the energy ray-curable resin (B) can be appropriately set based on the adhesive strength of a desired pressure sensitive adhesive layer 110. In an embodiment, the content of the acrylic resin (A) in the total content of the acrylic resin (A) and the energy ray-curable resin (B) is preferably 0 mass % or greater, more preferably 10 mass % or greater, even more preferably 20 mass % or greater, and particularly preferably 50 mass % or greater, and preferably 100 mass % or less, and more preferably 95 mass % or less.

The pressure sensitive adhesive composition constituting the pressure sensitive adhesive layer 110 may contain a component other than the resin. For example, the pressure sensitive adhesive composition may contain one or more selected from a cross-linking agent (C), a photopolymerization initiator (D), an antioxidant (E), or other additives.

### Cross-Linking Agent (C)

The pressure sensitive adhesive composition may contain a cross-linking agent (C) for bonding and cross-linking a functional group of the resin with another compound. Examples of the cross-linking agent (C) include isocyanate-based cross-linking agents (cross-linking agents having an isocyanate group) such as tolylene diisocyanate, hexamethylene diisocyanate, and xylylene diisocyanate, and adducts of these diisocyanates; epoxy-based cross-linking agents (cross-linking agents having a glycidyl group) such as ethylene glycol glycidyl ether; aziridine-based cross-linking agents (cross-linking agents having an aziridinyl group) such as hexa [1-(2-methyl)-aziridinyl]triphosphatriazine; metal chelate-based cross-linking agents (cross-linking agents having a metal chelate structure) such as aluminum chelates; and isocyanurate-based cross-linking agents (cross-linking agents having an isocyanuric acid backbone).

The pressure sensitive adhesive composition may contain one type of cross-linking agent or may contain two or more types of cross-linking agents. The content of the cross-linking agent (C) in the pressure sensitive adhesive composition is preferably 0.01 mass % or greater, more preferably 0.1 mass % or greater, and even more preferably 1 mass % or greater, and preferably 5 mass % or less, more preferably 4 mass % or less, and even more preferably 2 mass % or less, from the viewpoint of performing a cross-linking reaction properly.

### Photopolymerization Initiator (D)

The pressure sensitive adhesive composition may contain a photopolymerization initiator (D) initiating a cross-linking reaction upon energy being provided (e.g., irradiation of an energy ray). In a case where the pressure sensitive adhesive composition contains an energy ray-curable resin (B), by allowing the pressure sensitive adhesive layer 110 to contain the photopolymerization initiator (D), a cross-linking reaction proceeds even when relatively low energy energy is provided.

Examples of the photopolymerization initiator (D) include 1-hydroxycyclohexyl phenyl ketone, benzoin, benzoin methyl ether, benzoin ethyl ether, benzoin propyl ether, benzyl phenyl sulfide, tetramethylthiuram monosulfide, azobisisobutyronitrile, dibenzyl, diacetyl, 8-chloroanthraquinone, and bis(2,4,6-trimethylbenzoyl)phenylphosphine oxide.

The pressure sensitive adhesive composition may contain one type of polymerization initiator or may contain two or more types of polymerization initiators. The content of the photopolymerization initiator (D) in the pressure sensitive adhesive composition is preferably 0.01 mass % or greater, more preferably 0.1 mass % or greater, and even more preferably 1 mass % or greater, and preferably 10 mass % or less, more preferably 5 mass % or less, and even more preferably 2 mass % or less.

### Antioxidant (E)

The pressure sensitive adhesive composition may contain an antioxidant (E). Examples of the antioxidant (E) include a phenol-based antioxidant such as a hindered phenol-based compound, an aromatic amine-based antioxidant, a sulfur-based antioxidant, or a phosphorus-based antioxidant such as a phosphate-based compound.

Furthermore, the pressure sensitive adhesive composition constituting the pressure sensitive adhesive layer 110 may contain one or more selected from a UV absorber, a light stabilizer, a resin stabilizer, a filler, a pigment, an extender, a softener, or the like.

### Pressure Sensitive Adhesive Sheet Base Material

The pressure sensitive adhesive sheet base material 120 included in the pressure sensitive adhesive sheet according to the present embodiment functions as a support carrying the pressure sensitive adhesive layer 110. The type of pressure sensitive adhesive sheet base material 120 is not particularly limited and may be a hard base material or a flexible base material. Examples thereof include a plastic film film, a foil of a metal, such as aluminum or stainless steel, glassine paper, wood-free paper, coat paper, impregnated paper, and synthetic paper. In an embodiment, from the viewpoints of enhancing cushioning characteristics at the time of catching an element, facilitating installment to another member, enhancing releasability, facilitating lamination, or capability of being formed into a roll form, the pressure sensitive adhesive sheet base material 120 can be a flexible base material. As the pressure sensitive adhesive sheet base material 120, for example, a resin film can be used.

The resin film is a film containing a resin-based material as a main material, and may be made of a resin material or may contain an additive in addition to the resin material. The resin film may have laser beam transmittance.

Specific examples of the resin film include polyolefin-based films including polyethylene films, such as low density polyethylene films, linear low density polyethylene films, and high density polyethylene films, polypropylene films, polybutene films, polybutadiene films, polymethylpentene films, ethylene-norbornene copolymer films, and norbornene resin films; ethylene-based copolymer-based films, such as ethylene-vinyl acetate copolymer films, ethylene-(meth)acrylic acid copolymer films, and ethylene-(meth)acrylate copolymer films; poly(vinyl chloride)-based films, such as poly(vinylchloride) films and vinyl chloride copolymer films; polyester-based films, such as poly(ethylene terephthalate) films and poly(butylene terephthalate) films; polyurethane films; polyimide films; polystyrene films; polycarbonate films; and fluororesin films. Furthermore, a film containing a mixture of two or more types of materials, a cross-linked film obtained by cross-linking a resin forming these films, or a modified film such as an ionomer film may be used. Furthermore, the pressure sensitive adhesive sheet base material 120 may be a laminate film obtained by laminating two or more types of resin films.

From the viewpoint of general versatility, from the viewpoint of preventing warping because of relatively high strength, and from the viewpoint of heat resistance, the resin film can be a monolayer film selected from the group consisting of a polyethylene film, a polyester-based film, and a polypropylene film, or can be a laminate film obtained by laminating two or more types of films selected from this group.

From the viewpoint of providing supportability and roll winding properties in a compatible manner, the thickness of the pressure sensitive adhesive sheet base material 120 can be, but not particularly limited to, preferably 10 μm or greater, more preferably 25 μm or greater, and even more preferably 40 μm or greater, and preferably 500 μm or less, more preferably 200 μm or less, and even more preferably 90 μm or less. The range of the thickness of the pressure sensitive adhesive sheet base material 120 can be preferably 10 μm or greater and 500 μm or less, more preferably 25 μm or greater and 200 μm or less, and even more preferably 40 μm or greater and 90 μm or less.

### Another Layer

The pressure sensitive adhesive sheet may include a layer other than the pressure sensitive adhesive sheet base material 120 and the pressure sensitive adhesive layer 110. For example, an additional pressure sensitive adhesive layer may be provided on a face, which is on a side opposite to the pressure sensitive adhesive layer 110, of the pressure sensitive adhesive sheet base material 120. The pressure sensitive adhesive sheet may be adhered to another substrate, such as quartz glass, interposing the additional pressure sensitive adhesive layer therebetween. The type of additional pressure sensitive adhesive layer is not particularly limited, and for example, the additional pressure sensitive adhesive layer can be formed by using an ordinary adhesive agent.

### Method for Producing Pressure Sensitive Adhesive Sheet

The method for producing a pressure sensitive adhesive sheet is not particularly limited. In an embodiment, the pressure sensitive adhesive sheet in which the pressure sensitive adhesive layer 110 is provided on the pressure sensitive adhesive sheet base material 120 can be produced as described below. First, an organic solvent is added to a pressure sensitive adhesive composition constituting the pressure sensitive adhesive layer 110 described above, and thus a solution of a pressure sensitive adhesive composition is prepared. After a coating film is formed by applying this solution onto a pressure sensitive adhesive sheet base material 120, the coating film is dried, and thus the pressure sensitive adhesive layer can be provided on the pressure sensitive adhesive sheet base material 120. Furthermore, by performing a treatment to provide unevenness on a surface of this pressure sensitive adhesive layer, a pressure sensitive adhesive layer 110 having unevenness can be formed.

In another embodiment, the pressure sensitive adhesive sheet in which the pressure sensitive adhesive layer 110 is provided on the pressure sensitive adhesive sheet base material 120 can be produced as described below. First, an organic solvent is added to a pressure sensitive adhesive composition constituting the pressure sensitive adhesive layer 110 described above, and thus a solution of a pressure sensitive adhesive composition is prepared. After this solution is applied to a mold or a release sheet having unevenness that are reverse shapes to the unevenness of the pressure sensitive adhesive layer 110 described above (complementary unevenness) to form a coating film, the solution was dried to produce a pressure sensitive adhesive layer 110. By adhering the pressure sensitive adhesive layer 110 to a pressure sensitive adhesive sheet base material 120, a pressure sensitive adhesive sheet can be produced.

Examples of the organic solvent used to prepare a solution of the pressure sensitive adhesive composition include toluene, ethyl acetate, and methyl ethyl ketone. Examples of the method of coating the solution include a spin coating method, a spray coating method, a bar coating method, a knife coating method, a roll coating method, a roll knife coating method, a blade coating method, a die coating method, a gravure coating method, and a printing method (e.g., a screen printing method and an inkjet method).

In the production of the pressure sensitive adhesive sheet in an embodiment, treatment of providing unevenness on a surface of the pressure sensitive adhesive layer is not particularly limited. For example, unevenness can be provided on a surface of a pressure sensitive adhesive layer by using an imprint method. In the imprint method, a mold having a surface with a shape that is complementary to the unevenness to be provided can be used. Specifically, unevenness can be provided on a surface of the pressure sensitive adhesive layer by heating the pressure sensitive adhesive layer while the pressure sensitive adhesive layer provided on the pressure sensitive adhesive sheet base material is pressed with the mold. In a more specific method, a pressure sensitive adhesive layer is pressed with a mold, the pressure sensitive adhesive layer is maintained in heating for a predetermined time, then the pressure sensitive adhesive layer is cooled, and the mold can be removed. At the time of heating of the pressure sensitive adhesive layer, for example, the pressure sensitive adhesive layer can be heated to a temperature higher than the softening point of the pressure sensitive adhesive layer. Furthermore, the duration for maintaining the pressure sensitive adhesive layer in a heated condition is not particularly limited and, for example, may be 10 seconds or longer or may be 10 minutes or shorter. Examples of the specific method of heating the pressure sensitive adhesive layer while the pressure sensitive adhesive layer is pressed with a mold include a method of subjecting the pressure sensitive adhesive layer provided on the pressure sensitive adhesive sheet base material with a mold to vacuum-laminating. Note that, in place of performing the two step process of forming a pressure sensitive adhesive layer and forming unevenness, a pressure sensitive adhesive layer 110 having unevenness on a surface may be formed on a pressure sensitive adhesive sheet base material 120 in one step process.

As another method, a pressure sensitive adhesive layer 110 having unevenness shapes can be provided by spray-coating of a solution of the pressure sensitive adhesive composition. Furthermore, by adding a filler to the solution of the pressure sensitive adhesive composition and applying this solution, a pressure sensitive adhesive layer 110 having a rough or fibrous surface can be provided. As another method, a pressure sensitive adhesive layer having unevenness shapes can be directly provided on a pressure sensitive adhesive sheet base material by applying a solution of a pressure sensitive adhesive composition according to a desired pattern using a printing method such as an inkjet method.

Furthermore, a pressure sensitive adhesive sheet having no pressure sensitive adhesive sheet base material 120 can be produced by forming a pressure sensitive adhesive composition into a sheet form. Furthermore, the pressure sensitive adhesive layer may be formed by applying a liquid pressure sensitive adhesive containing a pressure sensitive adhesive composition to a freely chosen object. In these cases, a treatment for providing unevenness on a surface of a pressure sensitive adhesive layer may be performed after a pressure sensitive adhesive layer is formed, or a pressure sensitive adhesive layer may be formed by a method, which forms unevenness on a surface.

### Catching of Element

The pressure sensitive adhesive sheet according to the present embodiment can be used to catch an element distant from a holding substrate. For example, a pressure sensitive adhesive sheet can be used as a die-catching sheet for catching a die, such as a semiconductor die. This element is used for producing an electronic component or a semiconductor device.

### Preparation of Adhesive Sheet

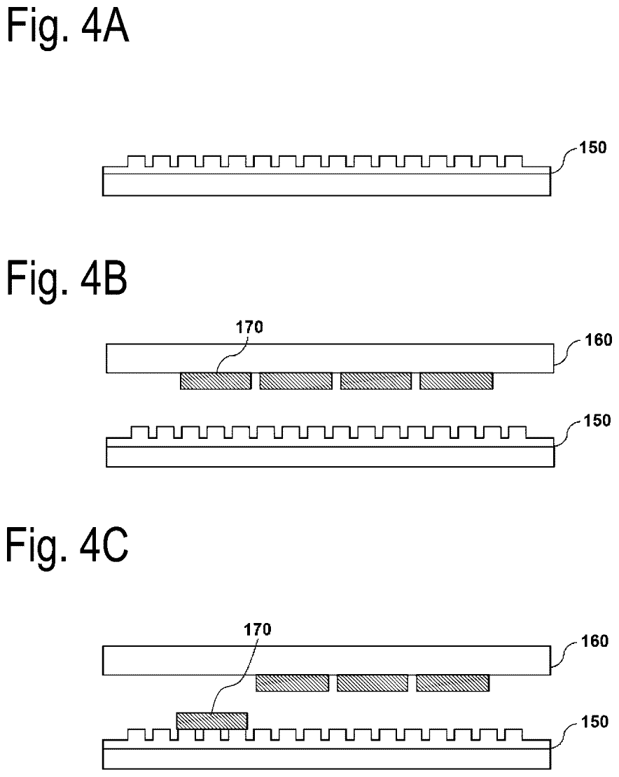

FIG. 4A to FIG. 4C are schematic views explaining separation and catching of an element. Supplement of an element from a holding substrate by a pressure sensitive adhesive sheet will be explained with reference to FIG. 4A to FIG. 4C. As illustrated in FIG. 1, in a laminate, typically, a pressure sensitive adhesive sheet and a release sheet are adhered until immediately before use. Immediately before the use, as illustrated in FIG. 4A, the release sheet is released from the laminate, and the pressure sensitive adhesive sheet 150 having unevenness on a pressure sensitive adhesive layer is prepared.

### Preparation of Element and Holding Substrate

As illustrated in FIG. 4B, an element 170 attached to a holding substrate 160 is prepared facing the pressure sensitive adhesive sheet 150.

### Element

The type of element is not particularly limited. Examples of the element include a semiconductor chip such as an LED chip, a semiconductor chip with a protective film, and a semiconductor chip with a die attach film (DAF). Furthermore, the element may be a micro LED, a mini LED, a power device, micro-electromechanical systems (MEMS), or a controller chip, or may be a component of these. Furthermore, the element may be a wafer, a panel, or a singulated material of substrate or the like. The element may have a circuit surface on which an integrated circuit having a circuit element such as a transistor, a resistor, and a capacitor is formed. Furthermore, an element is not necessarily limited to a singulated material and may be various wafers or various substrates that have not been singulated or the like.

The size of the element is not particularly limited. The size of the element may be, for example, preferably 100 μm² or greater, more preferably 500 μm² or greater, and even more preferably 1000 μm² or greater. Meanwhile, the size of the element is preferably 100 mm² or less, more preferably 25 mm² or less, and even more preferably 1 mm² or less. When an element having a small size is used, from the viewpoint of ease in selectively separating a small element, the laser lift-off method described below is suitable for separating the element.

Examples of the wafer include semiconductor wafers such as a silicon wafer, a silicon carbide (SiC) wafer, and a compound semiconductor wafer (e.g., a gallium phosphide (GaP) wafer, a gallium arsenide (GaAs) wafer, an indium phosphide (InP) wafer, and a gallium nitride (GaN) wafer). The size of the wafer is not particularly limited and is preferably 6 inches (diameter: approximately 150 mm) or greater, and more preferably 12 inches (diameter: approximately 300 mm) or greater. Note that a shape of the wafer is not limited to a circle and may be, for example, a quadrangle shape, such as a square or a rectangle.

Examples of the panel include a fan-out semiconductor package (e.g., FOWLP or FOPLP). That is, an object to be processed may be a semiconductor package before singulation or after singulation in the fan-out semiconductor package production technique. The size of the panel is not particularly limited and, for example, may be a rectangular substrate having a size of approximately 300 to 700 mm.

Examples of the substrate include a glass substrate, a sapphire substrate, or a compound semiconductor substrate.

### Holding Substrate

The type of holding substrate is also not particularly limited. For example, the holding substrate may be a pressure sensitive adhesive sheet or tray. The pressure sensitive adhesive sheet may include a pressure sensitive adhesive layer, and this pressure sensitive adhesive layer may be provided on a substrate. In this case, a holding substrate can hold an element on a pressure sensitive adhesive layer. The substrate may be a resin film or a hard substrate.

Such a preparation method of a holding substrate holding an element is also not particularly limited. For example, a semiconductor wafer may be adhered to a holding substrate, and then the semiconductor wafer may be diced. An element can be obtained by dicing the semiconductor wafer in this manner, and a holding substrate to which the element is adhered can be obtained.

As another method, an element obtained by dicing a semiconductor wafer is transferred to a holding substrate, and thus a holding substrate having the element adhered can be obtained. For example, a semiconductor wafer held on a wafer substrate is diced, and then the obtained element and a pressure sensitive adhesive layer of a holding substrate can be in close contact with each other. Thereafter, adhesion between the wafer substrate and the element can be reduced by providing an external stimulus such as a laser beam. By such a process, the element can be transferred from the wafer substrate to the holding substrate.

Note that, as described below, in an embodiment, the element is separated from the holding substrate by irradiation with a laser beam (laser lift-off method). In a case where such a method is used, the pressure sensitive adhesive layer of the holding substrate may contain a laser beam absorbent. Examples of the laser beam absorbent include one or more types selected from pigments and dyes.

### Separation and Catching of Element

As illustrated in FIG. 4C, by an external stimulus, the element 170 adhered to a holding substrate 160 is separated from the holding substrate 160, and allowed to be caught by the adhesive sheet 150. In an embodiment, the holding substrate 160 and the pressure sensitive adhesive sheet 150 are static, and the element 170 separated from the holding substrate 160 is moved to the pressure sensitive adhesive sheet 150. For example, in a case where the laser lift-off method described below is used, the element 170 can be moved to the pressure sensitive adhesive sheet 150 due to pressure of a gas generated by the laser beam irradiation. Meanwhile, movement of the element 170 is not necessary. For example, the holding substrate 160 may move to be separated from the element 170. Furthermore, the pressure sensitive adhesive sheet 150 may move to get closer to the element 170.

### Separation

The type of external stimulus in the separation of the element is not particularly limited, and examples thereof include providing energy, cooling, stretching of the holding substrate, and physical stimulus (e.g., pressing a back face of the holding substrate by using a pin or the like). By using one or more of these external stimuli, the bonding force between the holding substrate and the element is reduced, and the element can be separated from the holding substrate.

Examples of the method of providing energy include local heating, light irradiation, and heat irradiation. Furthermore, examples of the method of light irradiation include infrared irradiation, visible light irradiation, and laser beam irradiation. In an embodiment, a laser beam irradiation is performed as the external stimulus, that is, the separation of the element from the holding substrate is performed by the laser lift-off method. In this case, the laser beam is irradiated toward the adhered portion of a specific element on the holding substrate. For example, such laser beam irradiation can be performed from a face of a side opposite to the element of the holding substrate. A gas is generated at a contact portion between the specific element and the holding substrate. For example, when the laser beam is absorbed to the pressure sensitive adhesive layer, a gas is generated by sublimation of at least a part of the pressure sensitive adhesive layer. Due to the sublimation of at least a part of the pressure sensitive adhesive layer as described above, the adhesion area between the specific element and the pressure sensitive adhesive layer decreases, and thus the adhesive strength between the specific element and the holding substrate decreases. Furthermore, also due to the pressure of the generated gas, the adhesive strength between the specific element and the holding substrate decreases. As a result, the specific element is separated from the holding substrate.

The irradiation conditions of the laser beam are not particularly limited. From the viewpoint of selectively and efficiently separate some elements, the frequency of the laser beam is preferably 10000 Hz or greater and 100000 Hz or less. Furthermore, the beam diameter of the laser beam is preferably 10 μm or greater, and more preferably 20 μm or greater, and preferably 100 μm or less, and more preferably 40 μm or less. The output of the laser beam is preferably 0.1 W or greater and 10 W or less. The scanning speed of the laser beam is preferably 50 mm/see or greater and 2000 mm/see or less.

### Catching

As illustrated in FIG. 4C, the element 170 separated from the holding substrate 160 is caught by the pressure sensitive adhesive sheet 150. Specifically, the element 170 is relatively distant from the holding substrate 160. Furthermore, the element 170 becomes relatively closer to the pressure sensitive adhesive sheet 150. Due to the contact between the element 170 and the pressure sensitive adhesive layer 110 of the pressure sensitive adhesive sheet 150, the element 170 is caught by the pressure sensitive adhesive sheet 150.

The gas compressed in between the element and the pressure sensitive adhesive layer 110 caused by approach of the element and the pressure sensitive adhesive layer 110 is allowed to escape to a recessed portion of the pressure sensitive adhesive sheet. Due to the unevenness included in the pressure sensitive adhesive layer 110 as described above, the pressure caused between the element 170 and the pressure sensitive adhesive layer 110 can be relaxed. Thus, displacement of holding position of the element on the pressure sensitive adhesive sheet due to the pressure caused between the element and the pressure sensitive adhesive layer 110 can be suppressed.

### Release Sheet

### Release Layer

The release sheet according to the present embodiment includes a release layer 130, and the release layer 130 is a layer that is in contact with the pressure sensitive adhesive layer and may contain a resin. As described above, a surface of the release layer 130 has unevenness. The unevenness of the surface of the release layer 130 is in a complementary relationship with the unevenness of the surface of the pressure sensitive adhesive layer 110. That is, the shape or the protruded portion 111 of the pressure sensitive adhesive layer 110 is the same as the shape of the recessed portion 132 of the release layer 130, and the recessed portion 112 of the pressure sensitive adhesive layer 110 is the same as the shape of the protruded portion 131 of the release layer 130. Note that the release sheet may include two or more release layers 130. For example, the release sheet may include a laminate of one type or two or more types of release layers 130.

### Form of Release Layer

In an embodiment, the release layer 130 includes a plurality of recessed portions that are on the surface of the release layer 130, the plurality of recessed portions being separated from each other, and each of the plurality of recessed portions having a boundary defined by a protruded portion. Each of the plurality of recessed portions may be separated by a protruded portion continuous on the whole release layer 130. As described above, the unevenness of the surface of the release layer 130 is in a complementary relationship with the unevenness of the surface of the release layer 130, and specific shapes of the unevenness included on the surface of the release layer 130 are not limited.

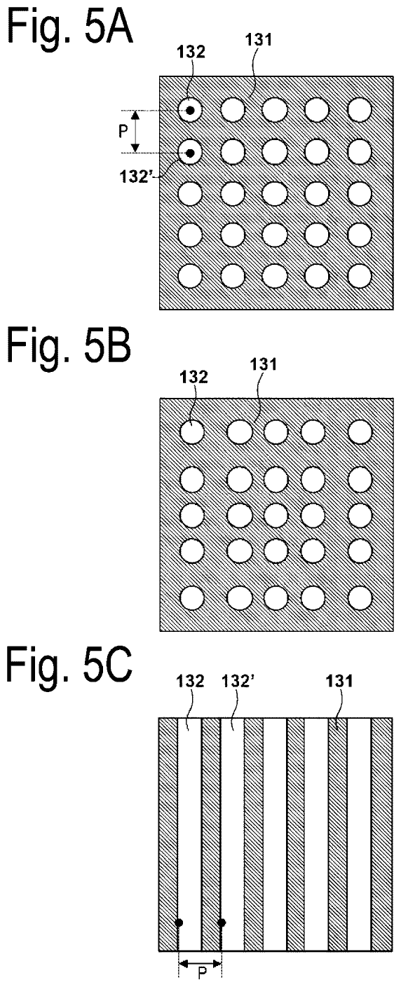

In an embodiment, a protruded portion positioned around each of the plurality of recessed portions continues to edges of the release layer 130. FIG. 5A to FIG. 5C are top views illustrating forms of such release layers 130. As illustrated in FIG. 5A, the recessed portions 132 may be regularly arranged on the surface of the release layer 130. Regular arrangement of the recessed portions 132 means that the recessed portions 132 are arranged in a straight line at a regular interval. Furthermore, as illustrated in FIG. 5B, the recessed portions 132 may be arranged in a manner that the spacing therebetween varies regularly. In the example of FIG. 5B, the spacing between the recessed portions 132 is smaller in a central part of the release sheet, and the spacing between the recessed portions 132 is longer in a peripheral part of the release sheet. Furthermore, the recessed portions 132 may be arranged irregularly.

FIG. 5C is a top view illustrating another form of the release layer 130. As illustrated in FIG. 5C, the surface of the release layer 130 may have recessed portions 132 in a stripe form. In FIG. 5C, linear recessed portions 132 having a fixed width are arranged at a regular interval. Meanwhile, similarly to FIG. 5B, widths or spacing of the linear recessed portions 132 may vary regularly, or the linear recessed portions 132 may be arranged irregularly.

Note that, similarly to FIG. 5B, the smallest spacing among all spacing of the recessed portions 132 in a central part of the release sheet may be shorter than the smallest spacing among all spacing of the recessed portions 132 in the peripheral part of the release sheet. Note that, for example, the central part is a circular region having ¼ area of the release sheet and having a center at the center of gravity of the release sheet. For example, the peripheral part is all region except the central part of the release sheet.

As described above, the unevenness of the surface of the release layer 130 is in a complementary relationship with the unevenness of the surface of the pressure sensitive adhesive layer 110. Thus, the pitch P of the recessed portions 132 of the release layer 130 can be the same as the pitch of the protruded portions 111 of the pressure sensitive adhesive layer 110. Because of this, the pitch of the recessed portions 132 is preferably 1 μm or greater, more preferably 5 μm or greater, even more preferably 10 μm or greater, and particularly preferably 15 μm or greater. Meanwhile, this pitch is preferably 100 μm or less, more preferably 75 μm or less, even more preferably 50 μm or less, yet even more preferably 35 μm or less, and particularly preferably 25 μm or less. Note that the pitch of the recessed portions 132 means a distance between a center point of one freely chosen recessed portion 132 and a center point of a recessed portion 132 that is the closest to the chosen recessed portion 132. For example, in the case of FIG. 5A, the pitch of the recessed portions 132 is a distance between a center point of the recessed portion 132 in the straight line, where recessed portions 132 are arranged at a regular interval, and a center point of another recessed portion 132′ that is the closest to the recessed portion 132. In a case where the plurality of the recessed portions 132 is arranged in a straight line, the pitch refers to a distance between center points of recessed portions that are arranged with the shortest pitch in the straight line. Furthermore, for example, in a case where a center point of a recessed portion is difficult to be identified due to a long and narrow form as illustrated in FIG. 5C, the spacing refers to a distance from a boundary of the recessed portion 132 to a boundary of the same side of the closest another recessed portion 132′.

The specific form of the recessed portion 132 is not particularly limited. For example, the recessed portion 132 may be a recess in a pillar (column) form. As a specific example, the recessed portion 132 may be a recess in a circular cylindrical shape or may be a recess in a prism shape. Furthermore, the recessed portion 132 may be a recess extended in a line form as described above or may be a recess extended in a curve form, such as a wave form. Furthermore, these recessed portions 132 may be tapered.

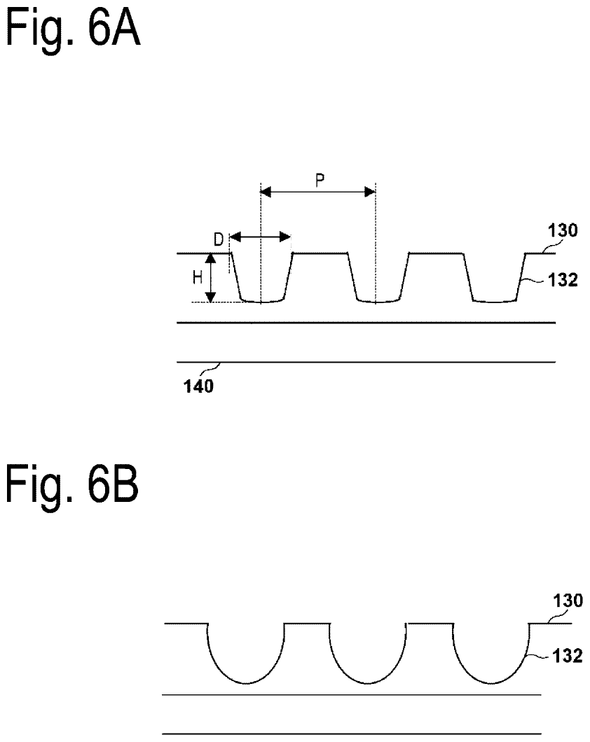

FIG. 6A illustrates a cross-sectional view seen vertically with respect to a surface of a release layer 130 passing through a recessed portion 132 of the release layer 130 according to an embodiment. The recessed portion 132 illustrated in FIG. 6A is provided with a taper, that is, the recessed portion 132 is tapered. As illustrated in FIG. 6A, a surface of the release layer 130 may include a flat protruded portion, and recessed portions 132 that are recessed from the protruded portion. As described above, a plurality of recessed portions 132, which are separated from each other, may have boundaries defined by the protruded portion.

Furthermore, as illustrated in FIG. 6B, the bottom of the recessed portion 132 may be semispherical or a curved face similar to a part of a sphere. Meanwhile, the bottom of the recessed portion may be a flat face. In another example, the recessed portion 132 may be recessed in a form having a plurality of particles aggregated, a form of lotus leaf surface, or a needle form. In another example, the surface of the release layer 130 may be a recess with a rough surface or fibrous surface, and these surfaces can be said to have unevenness.

As described above, the unevenness of the surface of the release layer 130 is in a complementary relationship with the unevenness of the surface of the pressure sensitive adhesive layer 110; however, to facilitate release of the pressure sensitive adhesive layer 110 from the release layer 130, the dimension of the recessed portion 132 of the release layer 130 described below may be the same as or larger than the dimension of the protruded portion 111 of the pressure sensitive adhesive layer 110.

The width or size of each of the recessed portions 132 is a width or size of a tip part, not a bottom part, and the width or size thereof is preferably 1 μm or greater, more preferably 2 μm or greater, even more preferably 5 μm or greater, and particularly preferably 10 μm or greater. Meanwhile, the width or size thereof is preferably 100 μm or less, more preferably 50 μm or less, even more preferably 30 μm or less, and particularly preferably 20 μm or less. Note that the width and the size of a recessed portion 132 respectively mean a minimum distance and a maximum distance between two parallel lines that are in contact with both sides of the recessed portion 132 at a surface of the protruded portion (represented as D in FIG. 6A).

Furthermore, the area of each of the recessed portions 132 is preferably 10 μm² or greater, more preferably 20 μm² or greater, and even more preferably 30 μm² or greater. Meanwhile, the area of each of the protruded portions 111 is preferably 2000 μm² or less, more preferably 1000 μm² or less, and even more preferably 500 μm² or less. Note that the area of the recessed portion 132 means an area of a part recessed from the surface of the protruded portion (area of a circle having a diameter D in the case of FIG. 6A).

Furthermore, the height (depth) of each of the recessed portions 132 is preferably 1 μm or greater, more preferably 3 μm or greater, and even more preferably 5 μm or greater. Meanwhile, the height (depth) of each of the recessed portions 132 is preferably 20 μm or less, more preferably 15 μm or less, and even more preferably 10 μm or less. Note that the depth of the recessed portion 132 is represented as H in FIG. 6A.

Furthermore, the area of each of the recessed portions 132 with respect to the area of the release layer 130 is preferably 1% or greater, more preferably 5% or greater, even more preferably 10% or greater, yet even more preferably 18% or greater, and particularly preferably 40% or greater. Meanwhile, the area of each of the recessed portions 132 with respect to the area of the release layer 130 is preferably 95% or less, more preferably 75% or less, and even more preferably 60% or less.

### Thickness of Release Layer

From the viewpoint of releasability, the thickness of the release layer 130 can be, but not particularly limited to, preferably 10 μm or greater, more preferably 15 μm or greater, and even more preferably 20 μm or greater, and preferably 50 μm or less, more preferably 45 μm or less, and even more preferably 40 μm or less. The range of the thickness of the release layer 130 can be preferably 10 μm or greater and 50 μm or less, more preferably 15 μm or greater and 45 μm or less, and even more preferably 20 μm or greater and 40 μm or less.

### Composition of Release Layer (Release Agent Composition)

The release agent composition constituting the release layer 130 contains a resin. In an embodiment, examples of the resin contained in the release agent composition include a polyolefin such as a polyethylene resin, a thermoplastic elastomer such as an olefin-based thermoplastic elastomer, a fluoro resin such as tetrafluoroethylene, and a mixture of these. Furthermore, the release agent composition constituting the release layer 130 may contain a non-silicone-based release agent (resin) or a non-silicone olefin-based release agent (resin). Examples of such a resin include a polyethylene resin and an olefin-based thermoplastic elastomer. When a silicone resin is contained in the release agent composition, a layer of a silicone compound derived from a silicone resin may be formed on a surface or the like of an element in production process. By allowing the resin contained in the release agent composition constituting the release layer 130 to contain a non-silicone-based release agent (resin) or a non-silicone olefin-based release agent (resin), a layer of the silicone compound is not formed on the surface or the like of the element in the production process, and a proper circuit can be formed.

In an embodiment, in a case where the resin contained in the release agent composition is an olefin-based thermoplastic elastomer and a polyethylene resin, the olefin-based thermoplastic elastomer and the polyethylene resin can be those satisfying the following conditions.

In an embodiment, the olefin-based thermoplastic elastomer can be an ethylene-propylene copolymer, an ethylene-octene copolymer, or the like. For example, the olefin-based thermoplastic elastomer can be an ethylene-propylene copolymer. By using the ethylene-propylene copolymer as the olefin-based thermoplastic elastomer, a release sheet having excellent releasability can be obtained.

The density of the olefin-based thermoplastic elastomer is not particularly limited and can be preferably 0.80 g/cm³ or greater, and more preferably 0.86 g/cm³ or greater. By this, heat resistance is enhanced. Furthermore, the density of the olefin-based thermoplastic elastomer can be preferably 0.90 g/cm³ or less, and more preferably 0.88 g/cm³ or less. By this, releasability is enhanced. The density of density of the olefin-based thermoplastic elastomer can be preferably 0.80 g/cm³ or greater and 0.90 g/cm³ or less, and more preferably 0.86 g/cm³ or greater and 0.88 g/cm³ or less.

In an embodiment, the polyethylene resin can be a polyethylene resin synthesized by using a transition metal catalyst such as a Ziegler-Natta catalyst or a metallocene catalyst. For example, a polyethylene resin synthesized by using a metallocene catalyst has excellent releasability and heat resistance.

The density of the polyethylene resin is not particularly limited and can be preferably 0.890 g/cm³ or greater, and more preferably 0.900 g/cm³ or greater. By this, heat resistance is enhanced. Furthermore, the density of the polyethylene resin can be preferably 0.925 g/cm³ or less, and more preferably 0.922 gg/cm³ or less. By this, releasability is enhanced. The density of density of the polyethylene resin can be preferably 0.890 g/cm³ or greater and 0.925 g/cm³ or less, and more preferably 0.900 g/cm³ or greater and 0.922 g/cm³ or less.

The mass ratio (blended ratio) of the olefin-based thermoplastic elastomer to the polyethylene resin is not particularly limited and can be preferably from 25:75 to 75:25, and more preferably from 40:60 to 60:4. By this, releasability and heat resistance are enhanced. Note that the release agent composition constituting the release layer 130 may contain another resin component and various additives, such as a plasticizer and a stabilizer.

### Release Sheet Base Material

The release sheet base material 140 included in the release sheet according to the present embodiment functions as a support carrying the release layer 130. The type of release sheet base material 140 is not particularly limited and may be a hard base material or a flexible base material. As the release sheet base material 140, for example, a resin film can be used. Furthermore, as the release sheet base material 140, those same as the pressure sensitive adhesive sheet base material 120 described above can be used.

From the viewpoint of providing supportability and roll winding properties in a compatible manner, the thickness of the release sheet base material 140 can be, but not particularly limited to, preferably 10 μm or greater, more preferably 20 μm or greater, and even more preferably 30 μm or greater, and preferably 200 μm or less, more preferably 150 μm or less, and even more preferably 100 μm or less. The range of the thickness of the release sheet base material 140 can be preferably 10 μm or greater and 200 μm or less, more preferably 20 μm or greater and 150 μm or less, and even more preferably 30 μm or greater and 100 μm or less.

### Another Layer

The release sheet may include another layer other than the release sheet base material 140 and the release layer 130. For example, an intermediate layer can be provided in between the release sheet base material 140 and the release layer 130 to improve adhesion of these.

### Method for Producing Release Sheet

The method for producing a release sheet is not particularly limited. In an embodiment, the release sheet in which the release layer 130 is provided on the release sheet base material 140 can be produced as described below. First, an organic solvent is added to a release agent composition constituting the release layer 130 described above, and thus a solution of a pressure sensitive adhesive composition is prepared. After a coating film is formed by applying this solution onto a release sheet base material 140, the coating film is dried, and thus the release layer can be provided on the release sheet base material 140.

Furthermore, by performing a treatment to provide unevenness on a surface of this release layer, a release layer 130 having unevenness can be formed.

In another embodiment, the release sheet in which the release layer 130 is provided on the release sheet base material 140 can be produced as described below. First, an organic solvent is added to a release agent composition constituting the release layer 130 described above, and thus a solution of a release agent composition is prepared. After this solution is applied to a mold or an adhesive sheet having unevenness that is reverse to the unevenness of the release layer 130 described above (complementary unevenness) to form a coating film, the solution was dried to produce a release layer 130. By adhering the release layer 130 to a release sheet base material 120, a release sheet can be produced.

As the organic solvent to be used for preparation of the solution of the release agent composition and the application method of the solution, those same for the pressure sensitive adhesive composition described above can be used.

In the production of the pressure sensitive adhesive sheet in an embodiment, treatment of providing unevenness on a surface of the release layer is not particularly limited. The method same for the pressure sensitive adhesive layer described above can be used.

Furthermore, a release sheet having no release sheet base material 140 can be produced by forming a release agent composition into a sheet form. Furthermore, the release layer may be formed by applying a liquid release agent containing a release agent composition to a freely chosen object. In these cases, a treatment for providing unevenness on a surface of a release layer may be performed after a release layer is formed, or a release layer may be formed by a method that forms unevenness on a surface.

### EXAMPLES

The present invention will be described in further detail below through the presentation of examples. However, the present invention is in no way limited to the examples described below. Part and % in examples are based on mass unless otherwise noted.

In Examples and Comparative Examples, the following compounds were used for production of the pressure sensitive adhesive sheets.

### Component (A)

Acrylic copolymer (A1): monomer ratio was 2-ethylhexylacrylate/2-hydroxyethylacrylate/acrylic acid=92.8/7.0/0.2; mass average molecular weight (Mw) was 1100000.

### Component (B)

Energy ray-curable resin (B1): product name “ARONIX M-920”, available from Toagosei Co., Ltd.

Energy ray-curable resin (B2): product name “ARONIX M-930”, available from Toagosei Co., Ltd.

### Component (C)

Cross-linking agent (C1): isocyanurate-type polyisocyanate derived from hexamethylene diisocyanate

### Component (D)

Photopolymerization initiator (D1): 1-hydroxycyclohexyl phenyl ketone

### Example 1

### Production of Pressure Sensitive Adhesive Sheet

In toluene, 100 parts by mass of acrylate copolymer (A), 5.0 parts by mass of energy ray-curable resin (B1), 0.5 parts by mass of cross-linking agent (C), and 0.15 parts by mass of photopolymerization initiator (D1) were dissolved, and thus a pressure sensitive adhesive composition was prepared. This pressure sensitive adhesive composition was applied onto a release-treated face of a process sheet (product name “SP-PET382150”, available from LINTEC Corporation; thickness: 38 μm), the obtained coating film was dried at 100° C. for 2 minutes, and thus a pressure sensitive adhesive layer having a thickness of 25 μm was formed. On this pressure sensitive adhesive layer, a base material (poly(ethylene terephthalate) film; thickness: 50 μm) was adhered, and thus a pressure sensitive adhesive sheet having no unevenness on the surface was prepared.

### Preparation of Release Sheet Having Unevenness on Surface

In toluene, 50 parts by mass of olefin-based thermoplastic elastomer containing an ethylene-propylene copolymer and 50 parts by mass of polyethylene resin were dissolved, and thus a release agent composition was prepared. This release agent composition was applied on a poly(ethylene terephthalate) film (thickness: 38 μm), the obtained coating film was dried at 100° C. for 2 minutes, and thus a release layer having a thickness of 20 μm was formed. Thereafter, a release layer was softened by heating at 160° C., a master mold having a protruded shape formed in advance was attached thereto, and thus a release sheet having unevenness shapes on the surface was prepared.

After the process sheet was released, the pressure sensitive adhesive layer of the pressure sensitive adhesive sheet was adhered to the release sheet having the unevenness shapes on the surface and vacuum-laminated at 60° C. for 300 seconds. Thereafter, using a UV irradiation device (available from Heraeus), irradiation with ultraviolet rays at an illuminance of 130 mW/cm² and a dose at 210 mJ/cm² was performed, and thus a laminate made of the pressure sensitive adhesive sheet having the unevenness shapes on the surface and the release sheet having the unevenness shapes on the surface was prepared.

The unevenness shapes included in the pressure sensitive adhesive layer of the pressure sensitive adhesive sheet were in forms, in which pillars were arranged in grid-like fashion in the same manner as in FIG. 2A. The pitch (P) between the pillars on the pressure sensitive adhesive sheet was 20 μm. Furthermore, the height (H) of each of the pillars illustrated in FIG. 3A was 8 μm, the diameter (T) of the tip part was 8 μm, and the diameter (D) of the base part was 16 μm. Furthermore, the ratio of the area of an adhered part between the pressure sensitive adhesive layer and an element to be caught (area of a tip face of the protruded portion) to the area of the pressure sensitive adhesive sheet was approximately 12.6%. Note that the unevenness shapes included in the pressure sensitive adhesive layer of the pressure sensitive adhesive sheet had surface shapes that were complementary to the unevenness shapes of the release sheet.

### Examples 2 to 4 and Comparative Examples 1 and 2

Laminates of Examples 2 to 4 and Comparative Examples 1 and 2 were each obtained in the same manner as in Example 1 except for changing the type of components and the blending proportions to those listed in Table 1.

### Reference Examples 1 and 2

Laminates of Reference Examples 1 and 2 were each obtained in the same manner as in Example 1 except for changing the type of components and the blending proportions to those listed in Table 1 and forming no unevenness on the surface of the pressure sensitive adhesive sheet.

### Peel Strength

The laminate obtained in each of Examples and Comparative Examples was cut to the size having the length of 150 mm and the width of 50 mm. Using a universal tensile testing machine (available from Shimadzu Corporation) in an environment at 23° C. and 50% RH (relative humidity), peel strength at the time of liner peeling of a release sheet (peel strength when the peeling was performed by folding the release sheet side at) 180° was measured at a pulling speed of 300 m/min by a 180° peel method. Each result for the peel strength was listed in Table 1.

TABLE 1

| | Component | Component | | Component | Component | Peel |
|---|---|---|---|---|---|---|
| | (A) | (B) | | (C) | (D) | strength |
| | A1 | B1 | B2 | C1 | DI | (mN) |
| Example 1 | 100 | 5.0 | 0 | 0.5 | 0.15 | 913 |
| Example 2 | 100 | 5.0 | 0 | 1.0 | 0.15 | 540 |
| Example 3 | 100 | 0 | 5.0 | 0.5 | 0.15 | 993 |
| Example 4 | 100 | 0 | 5.0 | 1.0 | 0.15 | 507 |
| Comparative | 100 | 5.0 | 0 | 0.1 | 0.15 | 4700 |
| Example 1 | | | | | | |
| Comparative | 100 | 0 | 5.0 | 0.1 | 0.15 | 4333 |
| Example 2 | | | | | | |
| Reference | 100 | 5.0 | 0 | 0.5 | 0.15 | 141 |
| Example 1 | | | | | | |
| Reference | 100 | 0 | 5.0 | 0.5 | 0.15 | 140 |
| Example 2 | | | | | | |

The laminates of Examples 1 to 4 each had a peel strength of 1000 mN/50 mm or less. Due to this, for each of the laminates of Examples 1 to 4, the pressure sensitive adhesive sheet having the unevenness on the surface was easily released from the release sheet.

On the other hand, the laminates of Comparative Examples 1 and 2 each had a peel strength of 1000 mN/50 mm or greater. Due to this, for each of the laminates of Comparative Examples 1 and 2, the pressure sensitive adhesive sheet having the unevenness on the surface could not be easily released from the release sheet.

The embodiments of the present invention are described above; however, the invention is not limited by the embodiments described above, and various variation and changes can be made within the gist of the present invention.

The present application claims priority from JP 2022-151756 filed on Sep. 22, 2022, JP 2022-151757 filed on Sep. 22, 2022, JP 2023-058459 filed on Mar. 31, 2023, JP 2023-058460 filed on Mar. 31, 2023, JP 2023-058462 filed on Mar. 31, 2023, and JP 2023-058463 filed on Mar. 31, 2023, the content of which is hereby incorporated by reference into this application.

1. A laminate comprising:
a pressure sensitive adhesive sheet configured to catch an element distant from a holding substrate; and
a release sheet laminated on one of faces of the pressure sensitive adhesive sheet, wherein
the pressure sensitive adhesive sheet includes a pressure sensitive adhesive layer, and the pressure sensitive adhesive layer includes an unevenness on a surface;
the release sheet includes a release layer that is in contact with the pressure sensitive adhesive layer, the release layer having unevenness on a surface; and
a peel strength at a release angle of 180° of the release sheet with respect to the pressure sensitive adhesive sheet measured at a release speed of 300 mm/min is 1000 mN/50 mm or less.

2. The laminate according to claim 1, wherein the release layer contains a non-silicone-based release agent.

3. The laminate according to claim 1, wherein the release layer contains a non-silicone olefin-based release agent.

4. The laminate according to claim 1, wherein the unevenness of the surface of the pressure sensitive adhesive layer is in a complementary relationship with the unevenness of the surface of the release layer.

5. The laminate according to claim 1, wherein
the release layer has a plurality of recessed portions on a surface of the release layer, each of the plurality of recessed portions having a boundary defined by a protruded portion, the plurality of recessed portions being separated from each other, and
a depth of a recessed portion of the release layer is 1 μm or greater.

6. The laminate according to claim 1, wherein the pressure sensitive adhesive layer is made of a pressure sensitive adhesive composition containing an energy ray-curable compound (B).

7. The laminate according to claim 1, wherein the pressure sensitive adhesive layer is made of a pressure sensitive adhesive composition containing an acrylic resin (A).

8. The laminate according to claim 1, wherein the pressure sensitive adhesive layer is made of a pressure sensitive adhesive composition containing an acrylic resin (A) and an energy ray-curable compound (B).

9. The laminate according to claim 1, wherein
the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and
a pitch between the plurality of protruded portions of the pressure sensitive adhesive layer is 1 μm or greater and 100 μm or less.

10. The laminate according to claim 1, wherein
the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and
an area of each of the plurality of protruded portions of the pressure sensitive adhesive layer is 10 μm² or greater and 2000 μm² or less.

11. The laminate according to claim 1, wherein
the pressure sensitive adhesive layer has a plurality of protruded portions on a surface of the pressure sensitive adhesive layer, each of the plurality of protruded portions having a boundary defined by a recessed portion, the plurality of protruded portions being separated from each other, and
a ratio of an area of each of the plurality of protruded portions of the pressure sensitive adhesive layer to an area of the pressure sensitive adhesive layer is 1% or greater and 95% or less.

12. The laminate according to claim 1, wherein the pressure sensitive adhesive layer has a ratio of an adhesion area of the pressure sensitive adhesive layer and one element to an area of the one element of 1% or greater and 95% or less.
